(19) United States
(12) Patent Application Publication
(10) Pub. No.: US 2016/0161959 A1
(43) Pub. Date: Jun. 9, 2016

(54) THERMAL MANAGEMENT METHOD AND ELECTRONIC SYSTEM WITH THERMAL MANAGEMENT MECHANISM

(71) Applicant: MEDIATEK INC., Hsin-Chu (TW)

(72) Inventors: Tsu-Ming Liu, Hsinchu City (TW); Tsio-Shan Chang, Tainan City (TW); Chi-Cheng Ju, Hsinchu City (TW); Chih-Ming Wang, Hsinchu County (TW)

(21) Appl. No.: 14/907,812

(22) PCT Filed: Jun. 12, 2015
(86) PCT No.: PCT/CN2015/081371

§ 371 Date: Jan. 26, 2016

Related U.S. Application Data
(60) Provisional application No. 62/011,189, filed on Jun. 12, 2014.

(51) Int. Cl. G05D 23/19; G05B 15/02

(52) U.S. Cl. CPC G05D 23/1917; G05B 15/02

(57) ABSTRACT

Disclosed is a thermal management method for controlling a temperature of a graphic processing module. The method comprises: (a) acquiring at least one device parameter corresponding to a first device of a graphic processing module; and (b) adjusting at least one operating parameter for a second device of the graphic processing module according to the device parameter to control a temperature of a graphic processing module.

### CROSS REFERENCE TO RELATED APPLICATIONS

This application claims the benefit of U.S. Provisional Application No. 62/011,189, filed on Jun. 12, 2014, the contents of which are incorporated herein by reference.

### TECHNICAL FIELD

The present invention relates to a thermal management method and an electronic system with a thermal management mechanism, and particularly relates to a thermal management method which can control a temperature for at least one device of a graphic processing module, and an electronic system with such thermal management mechanism.

### BACKGROUND

The temperature for an electronic apparatus is highly regarded, since a high temperature may affect the performance of the electronic apparatus, or makes the user feel un-comfortable, or even burns the user.

Therefore, the temperature of the electronic apparatus should be carefully controlled. For example, following IEC 62368-1, Audio/Video, Information Technology and Communication Technology Equipment—Part 1: Safety Requirement, the touch temperature limit for touchable surfaces is 48° C.

However, if the temperature of the electronic apparatus is desired to be decreased, the whole performance of the electronic apparatus is always suppressed to decrease the temperature.

### SUMMARY

Therefore, one objective of the present invention is to provide a thermal management method can adjust only few devices of the electronic system to control the temperature.

Another objective of the present invention is to provide an electronic system that can adjust only few devices thereof to control the temperature.

One embodiment of the present application is to provide a thermal management method, for controlling a temperature of a graphic processing module, comprising: (a) acquiring at least one device parameter for at least one first device of the graphic processing module; and (b) adjusting at least one operating parameter for at least one second device of the graphic processing module according to the device parameter.

Another embodiment of the present application is to provide an electronic system with a thermal control mechanism, comprising: a graphic processing module, configured to generate or display at least one frame; a parameter acquiring device, configured to acquire at least one device parameter for at least one first device of the graphic processing module; and a thermal management device, configured to adjust at least one operating parameter for at least second device of the graphic processing module according to the device parameter.

In view of above-mentioned embodiments, the temperature can be controlled via adjusting only a few devices, thus the performance for whole electronic apparatus would not greatly decrease.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating an electronic system applying a thermal management method according to one embodiment of the present invention.

FIG. 2 is a block diagram illustrating detail structures for the parameter acquiring device depicted in FIG. 1, according to one embodiment of the present invention.

FIG. 3 is a block diagram illustrating detail structures for the thermal management device depicted in FIG. 1, according to one embodiment of the present invention.

FIG. 4 is a block diagram illustrating detail structures for the graphic processing module depicted in FIG. 1, according to one embodiment of the present invention.

FIG. 5 is a flow chart illustrating a thermal management method according to one embodiment of the present invention.

FIG. 6 is a schematic diagram illustrating a thermal management method according to one embodiment of the present invention.

FIG. 7-FIG. 24 are schematic diagrams illustrating operations for the thermal management method according to different embodiments of the present invention.

### DETAILED DESCRIPTION

FIG. 1 is a block diagram illustrating an electronic system applying a thermal management method according to one embodiment of the present invention. The electronic system may be a mobile device or any other device. As illustrated in FIG. 1, the electronic system 100 comprises a graphic processing module 101, a parameter acquiring device 103 and a thermal management device 105. The graphic processing module 101 is a module that can process graphic data. In one embodiment, the graphic processing module 101 is a module that can draw a frame for a game program for display, but not limited. The parameter acquiring device 103 can acquire at least one device parameter DP corresponding to a first device in the graphic processing module 101. The thermal management device 105 adjusts at least one operating parameter DP for a second device of the graphic processing module 101 according to the device parameter DP. Please note the first device and the second device can be the same device, and can be different devices as well. For example, the first device and the second device are the same memory device. Alternatively, in another example, the first device is a display processor, but the second device is a graphic engine. Further, in still another example, a number of the first device or the second device is larger than 1, and the first device(s) and the second device(s) comprise at least one identical device.

In one embodiment of this invention, the thermal management device 105 may perform such adjustment without adjusting any setting or configuration of a central processing unit (CPU) of the electronic system 100. In another embodiment of this invention, the thermal management device 105 may further perform such adjustment to the setting or configuration of the CPU of the electronic system 100.

The device parameter DP can be a consequence parameter representing or indicating its temperatures. In one embodiment, the device parameter DP comprises at least one of following parameters or the combination thereof: a temperature, a current value, power consumption, a signal delay value, and any other kind of consequence parameter related to temperatures. In such example, directly according to the device parameter DP, the thermal management device 105 adjusts the operating parameter.

Alternatively, the device parameter DP can be a configuration parameter related to the temperature. In one embodiment, such device parameter DP comprises at least one of following parameters or the combination thereof: a frame rate, an exposure value, a frame resolution, a power consumption value, an operating speed, and any other kind of configuration parameter related to the temperature. In such example, the thermal management device 105 may acquire temperature related information or the temperature via the device parameter DP. For example, the thermal management device 105 can acquire temperature related information or the temperature via searching a pre-defined look up table based on the device parameter DP. In another example, the thermal management device 105 compute the device parameter DP to generate temperature related information or the temperature. In such example, the thermal management device 105 may compute or anticipate the temperature related value according to the device parameter DP first, and then adjusts the operating parameter accordingly. However, directly according to the configuration parameter DP, the thermal management device 105 may also adjust the operating parameter.

In one embodiment, the device parameter DP is generated by at least one operation performed by the first device. For example, the device parameter DP comprises at least one of following parameters or a combination thereof: a current required by the first device, and a temperature corresponding to the first device. Also, in another embodiment, the device parameter DP is an operating parameter of the first device. For example, the device parameter DP comprises at least one of following parameters or a combination thereof: an operating speed, an operating voltage, a brightness value, and a sharpness value.

Corresponding to different device parameters, the parameter acquiring device 103 can comprise different structures or configuration. For example, if the device parameter DP includes a temperature, the parameter acquiring device 103 may include a thermal sensor. Also, if the device parameter DP includes a frame rate, the parameter acquiring device 103 may access the operating parameter for the device in the graphic processing module 101. For example, access configuration of the frame rate in a decoder in the graphic processing module 101.

The operating parameter to be adjusted may include an operating speed, any configuration parameter (such as a frame rate, an exposure value, a frame resolution, a brightness value, an operating voltage, setting about level of detail, a rendering mode, or any other configuration parameter), any parameter about operating the second device, or combination thereof.

Please note the device parameter DP and the operating parameter are not limited to above-mentioned examples. Further examples for the device parameter DP and the operating parameter will be explained later.

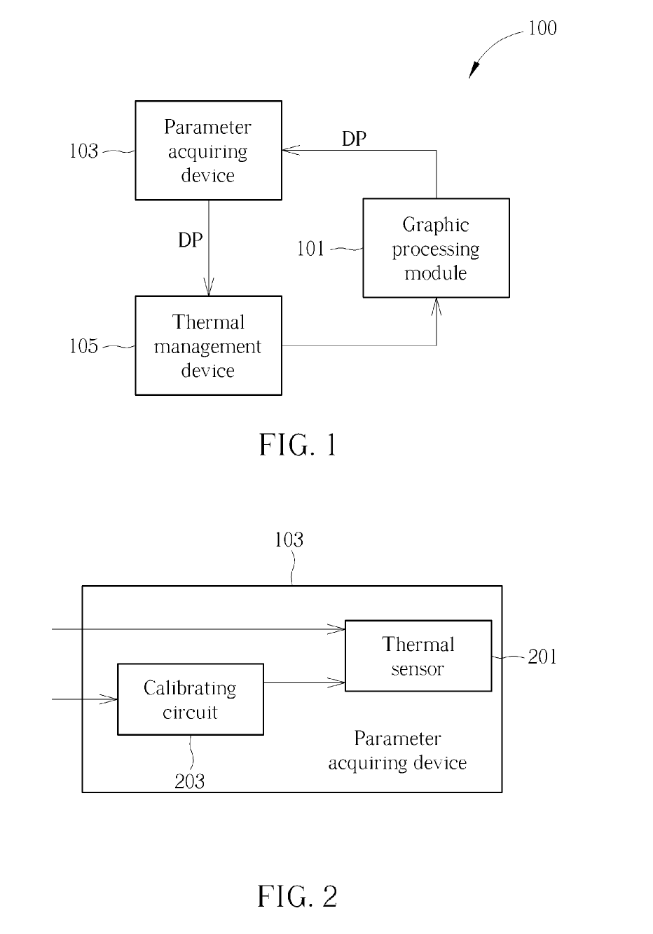

FIG. 2 is a block diagram illustrating detail structures for the parameter acquiring device 103 depicted in FIG. 1, according to one embodiment of the present invention. In this embodiment, the parameter acquiring device 103 may include a thermal sensing module, which can sense a parameter representing or indicating temperatures, for example, a temperature, a current value, a signal delay value which is related to temperature variation or any other value related to the temperature. The parameter acquiring device 103 may include a thermal sensor 201, which directly senses the device parameter for the device in the graphic processing module. In some embodiments, the thermal sensor 201 may include an inverter chain which is temperature dependent. In one embodiment, the parameter acquiring device 103 further comprises a calibrating circuit 203, which is configured to minimize the measurement errors. The calibrating circuit 203 may be performed according to environmental temperature or information about the type of thermal sensor 201. In some embodiments, the calibration may be realized by table-look-up via off-line process. In some other embodiments, the calibration may be implemented via external thermometer or internal logic.

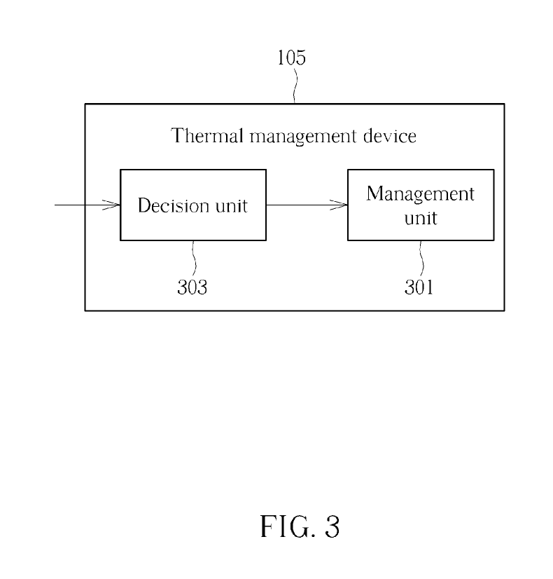

FIG. 3 is a block diagram illustrating detail structures for the thermal management device depicted in FIG. 1, according to one embodiment of the present invention. In this embodiment, the thermal management device 105 comprises a management unit 301 and a decision unit 303. The decision unit 303 is configured to determine if the management unit 301 should be enabled or not according received parameters. For example, if the decision unit 303 receives a temperature, a current value, or a value representing or indicating the temperature is higher than a corresponding threshold value, the decision unit 303 enables the management unit 301 to start thermal management.

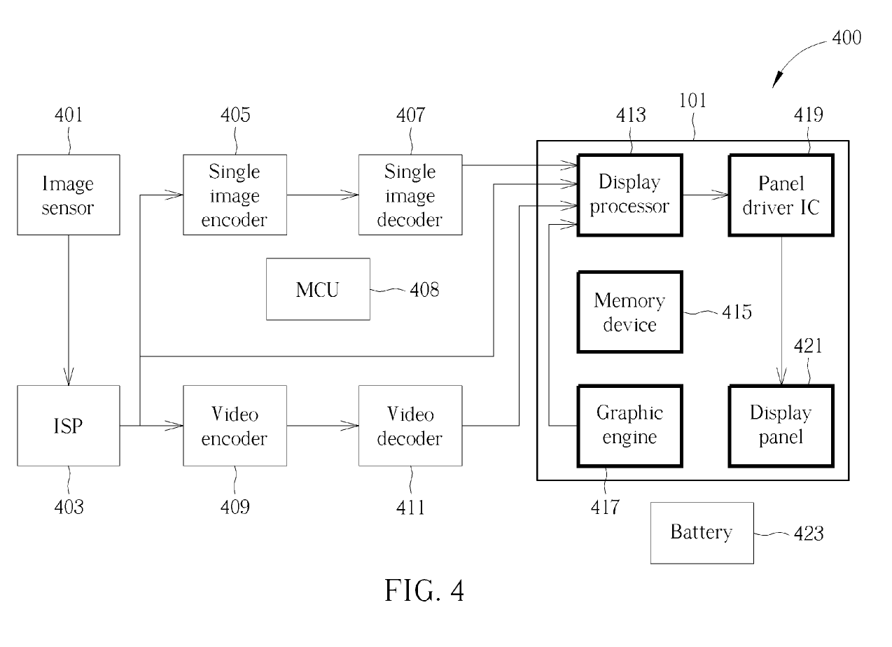

FIG. 4 is a block diagram illustrating detail structures for the graphic processing module 101 depicted in FIG. 1, according to one embodiment of the present invention. As shown in FIG. 4, an image processing module 400 may comprise at least one of: an image sensor 401, an image signal processor 403, a single image encoder 405, a single image decoder 407, a micro control unit 408, a video encoder 409, a video decoder 411, a display processor 413, a memory device 415, a graphic engine 417, a panel driver IC 419, a display panel 421, and a battery 423.

The image sensor 401 is configured to sense images (e.g. taking pictures). The image signal processor 403 is configured to process image signals from the image sensor 401. The single image encoder 405 and the single image decoder 407 are applied to process independent images (e.g. pictures) for image encoding and decoding respectively. Also, the micro control unit 408 is configured to control the operations for devices in the graphic processing module 101. The video encoder 409, the video decoder 411 are applied to process video data comprising a plurality of images (e.g. video stream) for video encoding and decoding respectively. The display processor 413 is configured to process images or video data from the image signal processor 403, the single image decoder 407, the video decoder 411 or the graphic engine 417, to generate images or video data that can be displayed on the display panel 421. The memory device 415 (e.g. a DRAM) is configured to store images or video data, and the stored images or video data can be accessed and displayed on the display panel 421. The graphic engine 417 is configured to draw an image. The panel driver IC 419 is configured to drive the display panel 421.

The image processing module 400 comprises the graphic processing module 101 depicted in FIG. 1. In the embodiment depicted in FIG. 4, the graphic processing module 101 may comprise at least one of the display processor 413, the memory device 415, the graphic engine 417, the panel driver IC 419, and the display panel 421. Accordingly, such graphic processing module 101 can draw a frame via the graphic engine 417 for displaying via the display panel 421. However, the graphic processing module 101 is not limited to comprise devices described here, it may comprise at one or more the devices of the display processor 413, the memory device 415, the graphic engine 417, the panel driver IC 419, and the display panel 421 and the micro control unit 408. Please note, if the graphic processing module 101 comprises the micro control unit 408, the above-mentioned operation of adjusting the operating parameter of the second device may comprise adjusting the operating frequency of the micro control unit 408, but not limited.

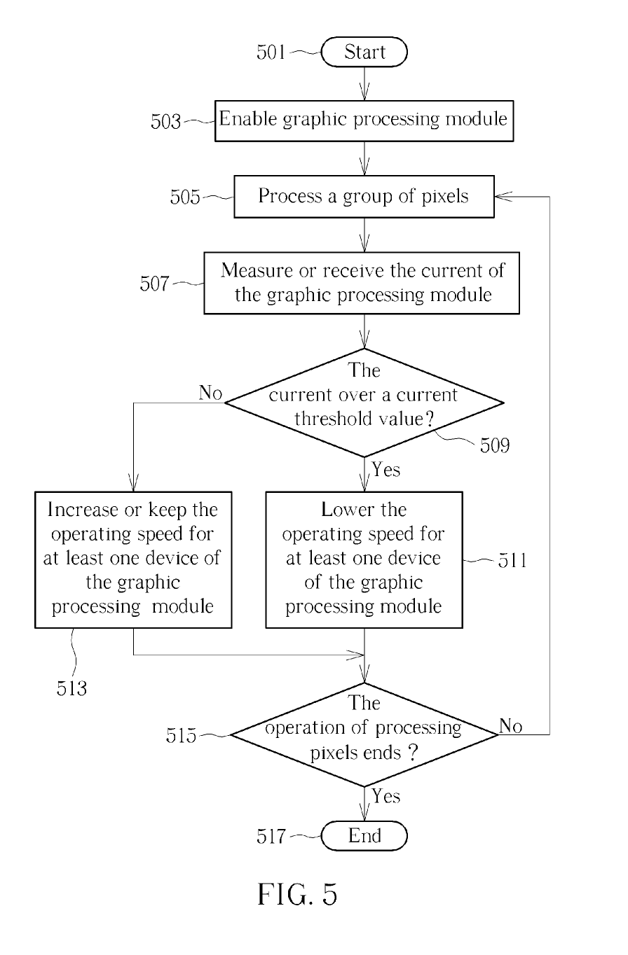

In some embodiments of FIG. 4, if the graphic processing module is applied to draw frames for a 3D game program, at least one of the display processor 413, the memory device 415, the graphic engine 417, the panel driver IC 419 and the display panel 421 tends to generate thermal. Therefore, these devices are applied as examples in the embodiments depicted in FIG. 5-FIG. 24. Please note these examples are only for explaining and do not mean to limit the scope of the present invention.

FIG. 5 is a flow chart illustrating a thermal management method according to one embodiment of the present invention. The flow chart in FIG. 5 comprises:

Step 501

Start

Step 503

Graphic processing module 101 may be enabled. In one embodiment, the graphic processing module may be applied to draw frames for a 3D game program, but not limited.

Step 505

Process a group of pixels. The pixels can be received from the memory device 415, or from any other source inside or outside the graphic processing module 101.

Step 507

Measure or receive the current value (i.e. the above-mentioned device parameter) corresponding to a first device of the graphic processing module 101. Please note, in some embodiments of the step 507, the current value for only one device of the graphic processing module 101 (e.g. the graphic engine 417) may be measured or received, or a current amount for several devices of the graphic processing module 101 may be measured or received (e.g. the memory device 415 and the display processor 413). In some embodiments of step 507, if the graphic processing module 101 is enabled to draw frames for a 3D game program, the current value for the display processor 413, the memory device 415, the graphic engine 417, the panel driver IC 419, the display panel 421 or combination thereof may be measured or received. In some other embodiments of the step 507, the current value of the battery 423 may be measured or received to represent the current value of the image processing module 101.

Step 509

Determine if the current measured or received in the step 507 is over a current threshold value or not. If yes, go to step 511, if not, go to step 513.

Step 511

Lower the operating speed (i.e. the above-mentioned operating parameter) for a second device of the graphic processing module 101. In one embodiment of step 511, the second device of the graphic processing module 101 may mean at least one of: the display processor 413, the memory device 415, the graphic engine 417, the panel driver IC 419 and the display panel 421.

Step 513

Increase or keep the operating speed for the second device of the graphic processing module 101.

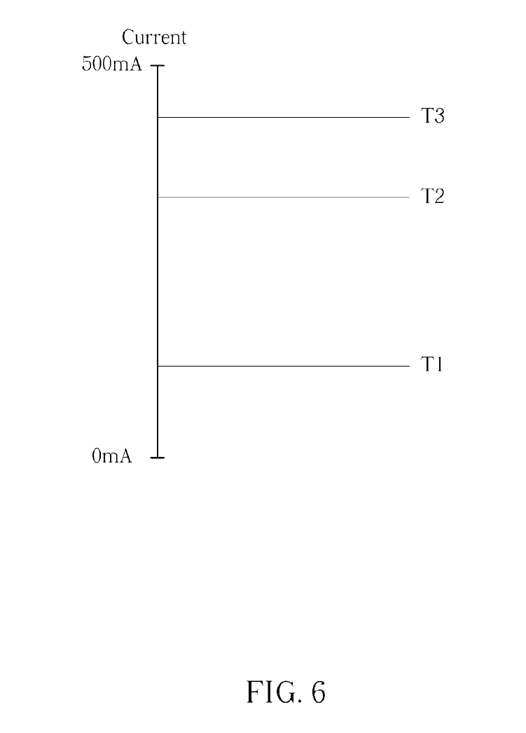

In one embodiment, several current threshold values can be provided, such as FIG. 6. In such embodiment, the step 511 is performed according to which range the current value measured or received in the step 507 locates in. For example, if the current is above the current threshold value T1 but below the current threshold value T2, the step 511 lowers the operating speed to a first level. Also, if the current value is above the current threshold value T2 but below the current threshold value T3, the step 511 lower the operating speed to a second level lower than the first level.

Step 515

If the operation of processing pixels ends may be determined. If yes, go to step 517, if not, go back to the step 505.

Step 517

End.

Since the current measured or received in the step 507 is a parameter representing or indicating the temperature, thus the step 507 can be regarded as a step for “acquiring device parameter representing or indicating temperature”. In other embodiments, a temperature, a current value, a signal delay value any other device parameter representing or indicating the temperature or combination thereof may be acquired.

In another embodiment, the step 507 is replaced with a step for “acquiring a device parameter that can be applied to acquire temperate related information or a temperature”. For example, acquire a frame rate, an exposure value, a frame resolution, an operating speed, or any other parameter related to the temperature. In such embodiment, the step 509 is correspondingly replaced by another step. For example, if the step 507 is replaced by a step of acquiring a frame resolution, the step 509 is replaced by a step of “determining if the frame resolution is over a resolution threshold value”. Please note, such step 507 can also be replaced with “acquiring a device parameter generated by at least one operation performed by the first device”, or be replaced with “acquiring a device parameter which is an operating parameter of the first device”.

For such embodiment, several resolution threshold values may be provided as well. As shown in following Table 1, several resolution threshold values are provided, and the operating speed may be adjusted to different values corresponding to which range the frame resolution located in. For example, but not limitation, when resolution is high, temperature may also go high. Therefore, when resolution is high, a low operating speed is set.

TABLE 1

| Resolution threshold | Adjustment |
|---|---|
| 1920 × 1080 | Operating speed level 1 |
| 4096 × 2160 | Operating speed level 2 |
| 7680 × 4320 | Operating speed level 3 |

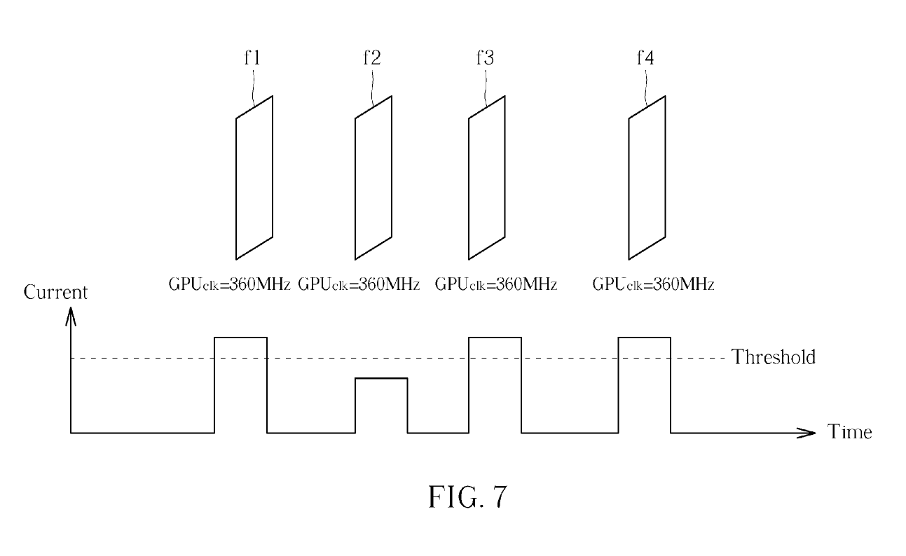

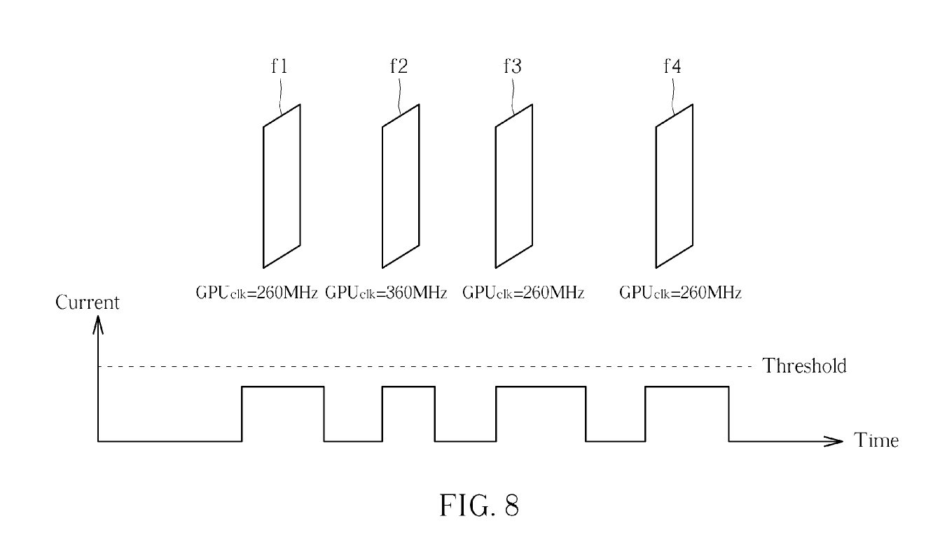

FIG. 7-FIG. 24 are schematic diagrams illustrating operations for the thermal management method according to different embodiments of the present invention. In the embodiments depicted of FIG. 7, FIG. 8, the operating speed for the graphic engine is adjusted based on the current generated by at least one first device which includes or excludes the graphic engine in the graphic processing module. Please note the operating speed is adjusted via adjusting a clock rate of the graphic engine in the embodiment depicted in FIG. 7 and FIG. 8. However, other methods can be applied to adjust the operating speed of the graphic engine. Further, the combination of current and operating speed can be applied to other devices of the graphic processing module.

Please refer to FIG. 7, the graphic engine (or called graphic processing unit (GPU)) initially operates at the clock rate 360 MHz at the time points for drawing frames f1, C, f3, f4. However, the measured or received current is over a current threshold value at the time points for drawing frames f1, f3, f4. Accordingly, in the embodiment of FIG. 8, the clock rates for the graphic engine at the time points for drawing frames f1, f3, f4 are adjusted to 260 MHz. By this way, the current at the time points for drawing frames f1, f3, f4 may be suppressed. Please note, in such embodiment, the graphic engine also operates at the clock rate 360 MHz at the time point for processing the frame C. However, the current at the time point for processing the frame f2 is still lower than the current threshold value.

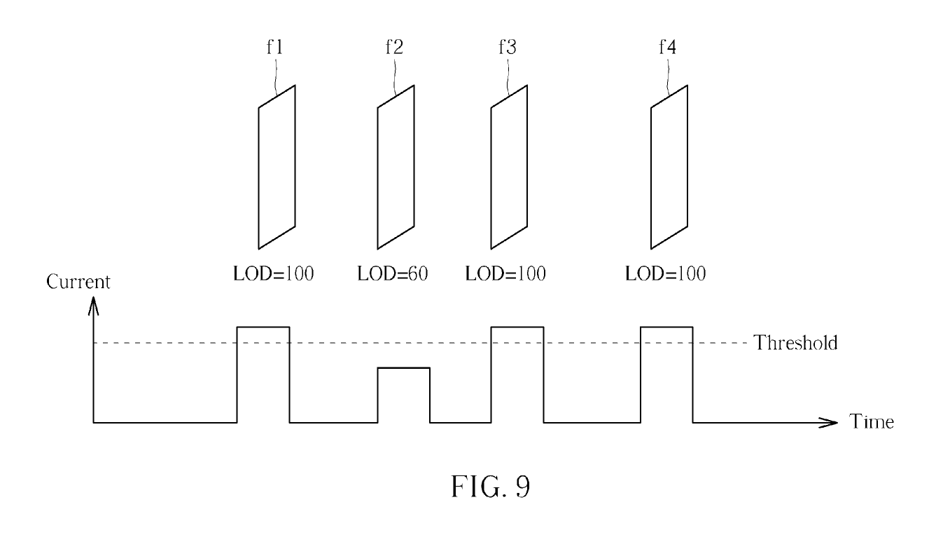

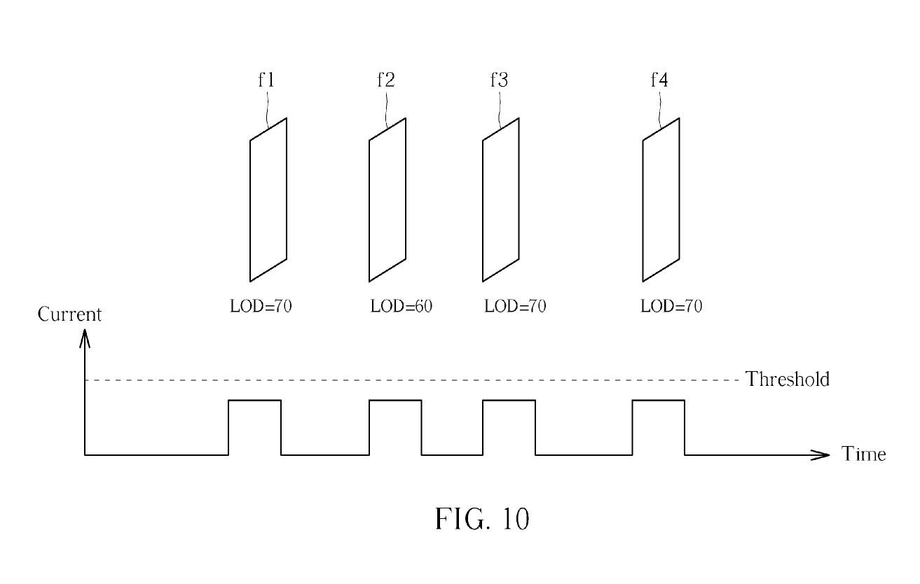

In the embodiments depicted in FIG. 9, FIG. 10, the frame detail level for the graphic engine is adjusted based on the current generated by at least one first device which includes or excludes the graphic engine in the graphic processing module. The frame detail level is a parameter indicating how detail does the graphic engine draws the frame. The more detail the frame is drawn, the more power does the graphic engine consumes thus more thermal is generated. In the embodiments of FIG. 9 and FIG. 10, the frame detail level is indicated by a LOD (level of detail) value, the higher the LOD value, the more detail for the frame drawn by the graphic engine.

Please refer to FIG. 9, the graphic engine is set to higher LOD values for frames f1, f3, f4, thus the measured or received current value is over a current threshold value at the time points for drawing frames f1, f3, f4. Accordingly, in the embodiment of FIG. 10, the LOD values for the frames f1, f3, f4 are decreased to 70. By this way, the current value at the time points for drawing frames f1, f3, f4 may be suppressed correspondingly.

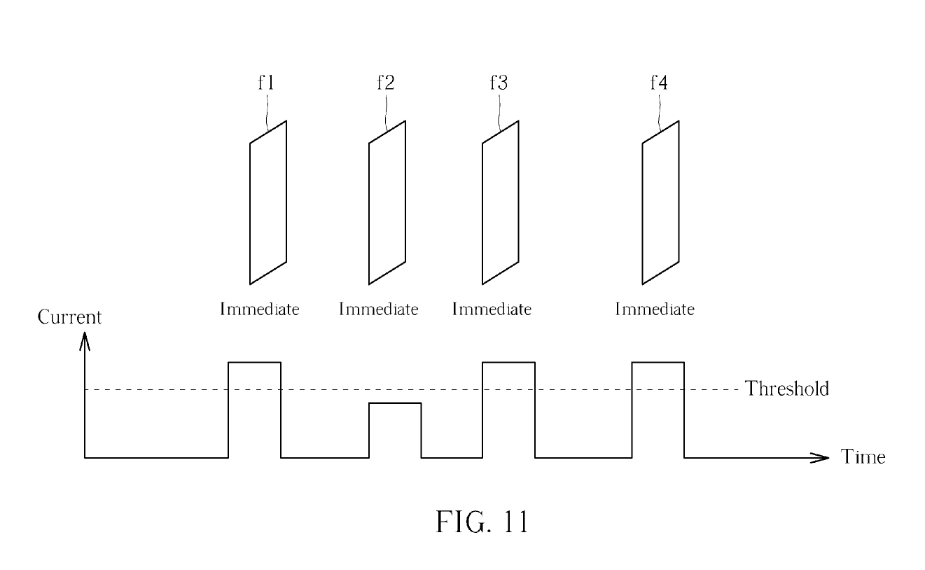

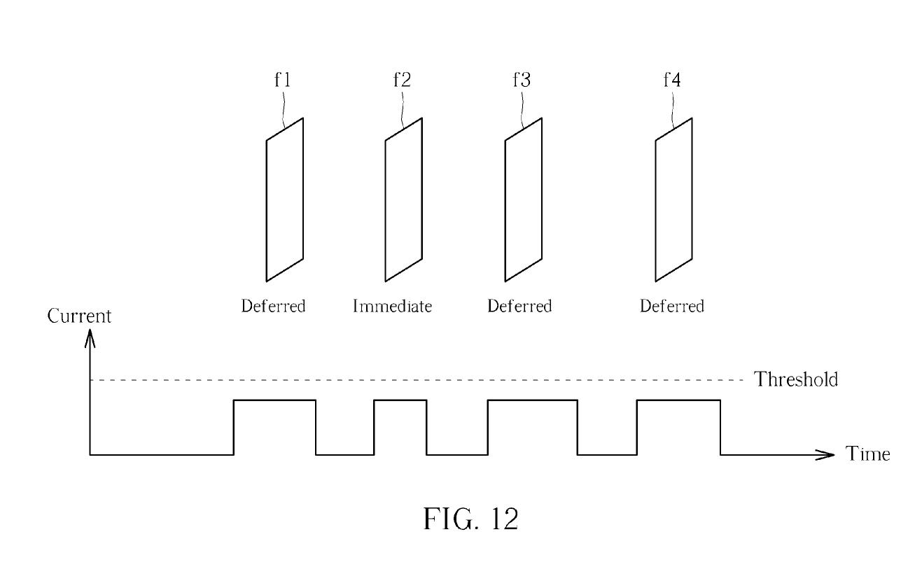

In the embodiments of FIG. 11, FIG. 12, the rendering mode for the graphic engine is adjusted based on the current generated by at least one first device which includes or excludes the graphic engine in the graphic processing module. The rendering mode indicates how the frame is drawn. For example, an immediate mode is a mode that immediately draws features commanded in the drawing instruction, thus a previously drawn feature may be covered by another feature drawn afterwards. Also, the drawing instructions and related data are directly transmitted to pipelines. Accordingly, such mode may finish a simple task quickly and easily, but the memory device needs a larger bandwidth, the graphic engine consumes much power, thus the temperature may increase. A deferred mode is a mode that will temporarily buffer drawing instructions and omit some features that should not be drawn via analyzing the buffered drawing instructions. In such mode, the data is organized more preferably, a smaller memory bandwidth is needed, and the graphic engine consumes less power.

Please refer to FIG. 11, the graphic engine operates in the immediate mode to draw frames f1, f2, f3, f4, and the measured or received current is over a current threshold value at the time points for drawing frames f1, f3, f4. Accordingly, in the embodiment of FIG. 12, the graphic engine is adjusted to operate in the deferred mode to draw the frames f1, f3, f4. By this way, the current at the time points for drawing frames f1, f3, f4 can be suppressed correspondingly.

Please note, the immediate mode and the deferred mode are only examples for explaining. The graphic engine can be adjusted to operate in other rendering modes according to the measured or received current values, or other device parameters.

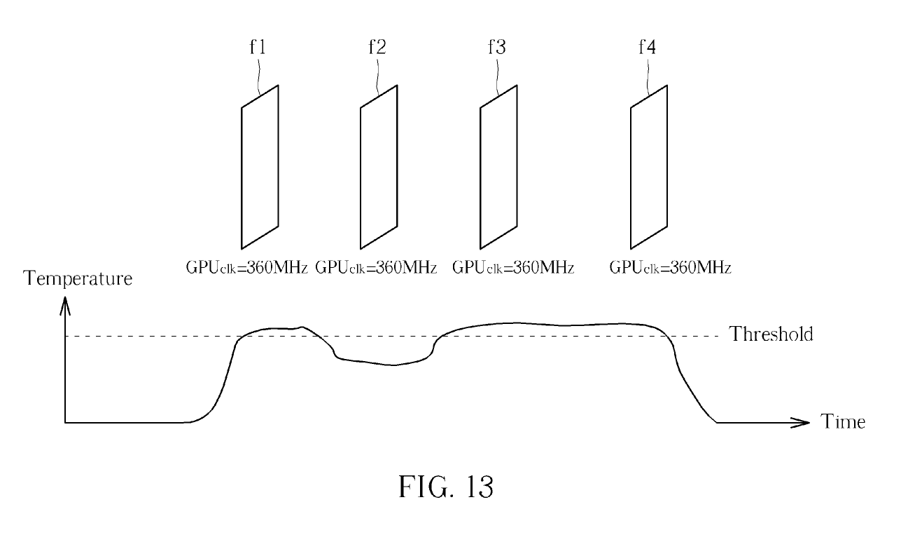

As above-mentioned, the device parameter can be various kinds of parameters. In the embodiments of FIG. 13-18, the current value is replaced with a temperature.

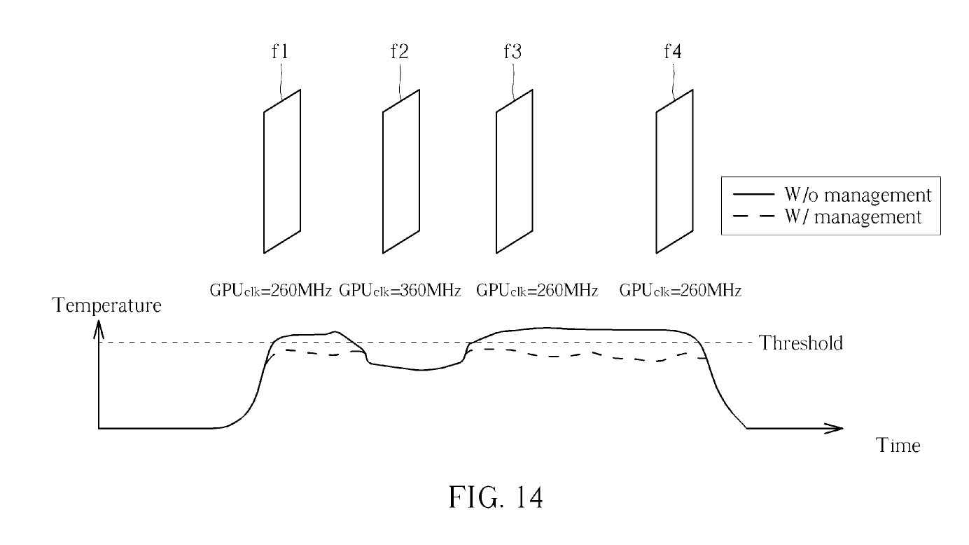

In the embodiments depicted of FIG. 13, FIG. 14, the operating speed for the graphic engine is adjusted based on the temperature corresponding to a first device which includes or excludes the graphic engine in the graphic processing module. As above-mentioned, the operating speed is adjusted via adjusting a clock rate of the graphic engine in the embodiment depicted in FIG. 13 and FIG. 14. However, other methods can be applied to adjust the operating speed of the graphic engine. Further, the combination of temperature and operating speed or relation between them may be applied to other devices of the graphic processing module.

Please refer to FIG. 13, the graphic engine initially operates at the clock rate 360 MHz at the time points for drawing frames f1, f2, f3, f4. However, the temperature is over a temperature threshold value at the time points for drawing frames f1, f3, f4. Accordingly, in the embodiment of FIG. 14, the clock rates for the graphic engine at the time points for drawing frames f1, f3, f4 are adjusted to 260 MHz. By this way, the temperature at the time points for drawing frames f1, f3, f4 may be suppressed correspondingly.

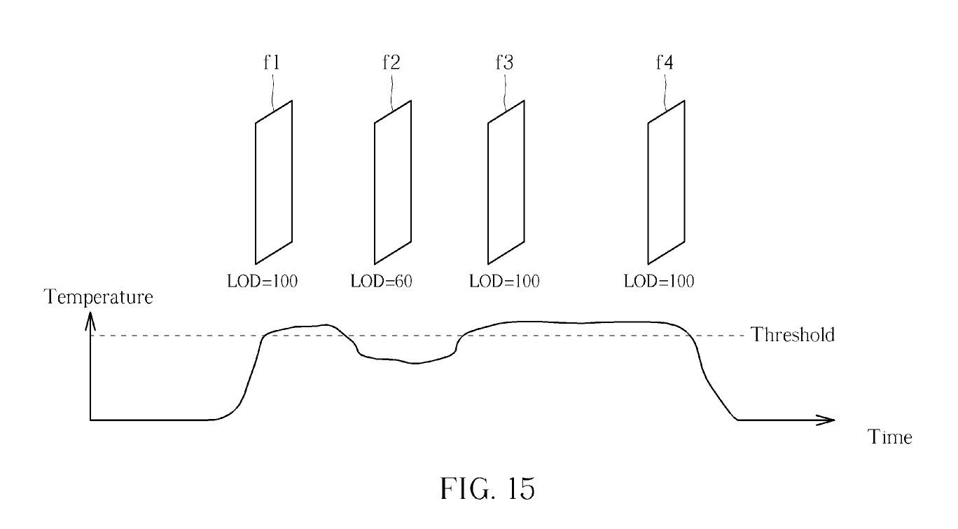

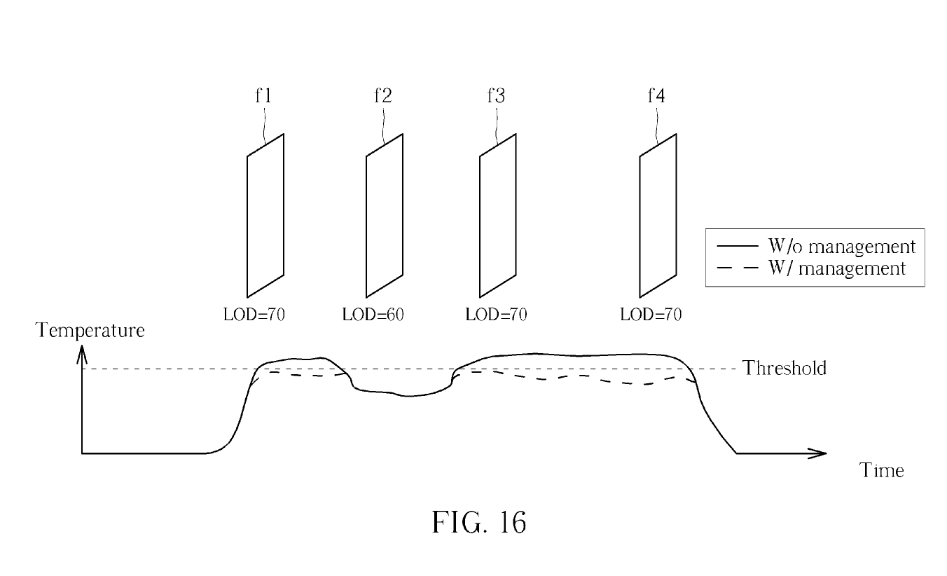

In the embodiments depicted in FIG. 15, FIG. 16, the frame detail level for the graphic engine is adjusted based on the temperature generated by at least one first device which includes or excludes the graphic engine in the graphic processing module. As above-mentioned, the frame detail level is a parameter indicating how detail the graphic engine draws the frame. In the embodiments of FIG. 15, FIG. 16, the frame detail level is indicated by a LOD (level of detail) value, the higher the LOD value, the more detail for frame drawn by the graphic engine.

Please refer to FIG. 15, the graphic engine is set to higher LOD values for frames f1, f3, f4, and the temperature is over a temperature threshold value at the time points for drawing frames f1, f3, f4. Accordingly, in the embodiment of FIG. 16, the LOD values for the frames f1, f3, f4 are decreased to 70. By this way, the temperature at the time points for drawing frames f1, f3, f4 may be suppressed correspondingly. The graphic engine is set to a lower LOD value for the frame f2, and the corresponding temperature is lower than a temperature threshold value.

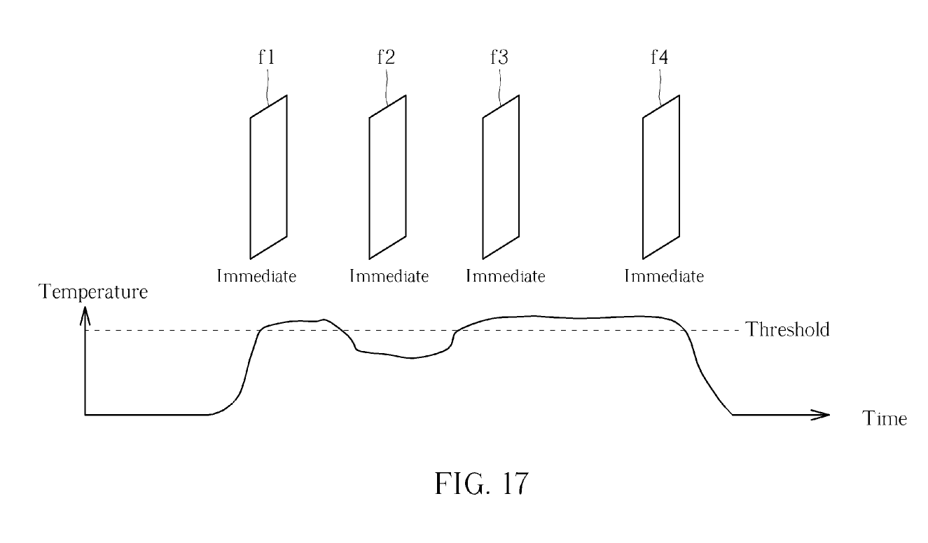

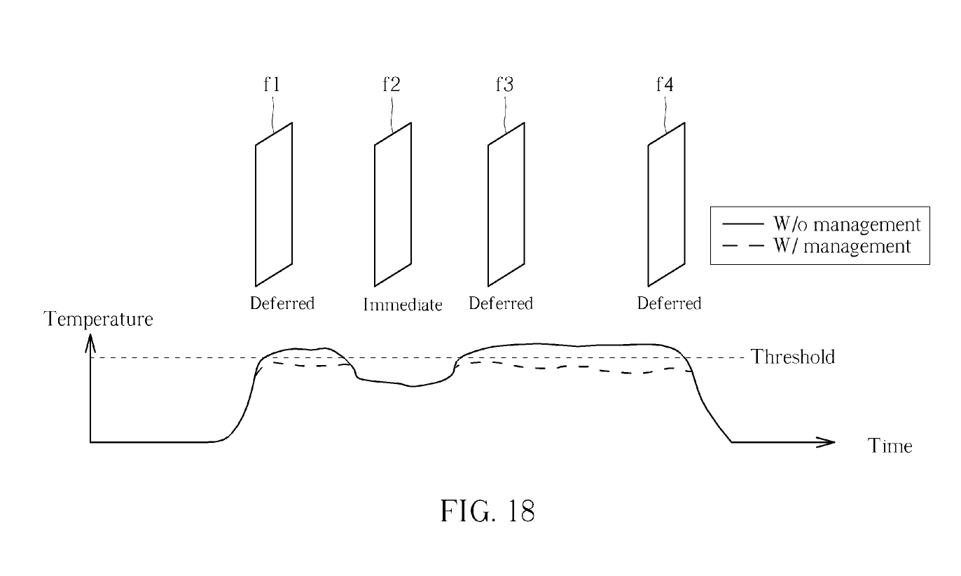

In the embodiments depicted in FIG. 17, FIG. 18, the rendering mode for the graphic engine is adjusted based on the temperature generated by at least one first device which includes or excludes the graphic engine in the graphic processing module. As described in the embodiments of FIG. 11 and FIG. 12, the rendering mode indicates how the frame is drawn. Also, the rendering mode may be selected from an immediate mode consuming more power and a deferred mode consuming less power.

Please refer to FIG. 17, the graphic engine operates in the immediate mode to draw frames f1, f2, f3, f4, and the measured or received temperature value is over a temperature threshold value at the time points for drawing frames f1, f3, f4. Accordingly, in the embodiment of FIG. 18, the graphic engine is adjusted to operate in the deferred mode to draw the frames f1, f3, f4. By this way, the temperature at the time points for drawing frames f1, f3, f4 may be suppressed correspondingly.

As above-mentioned, the immediate mode and the deferred mode are only examples for explaining. The graphic engine may be adjusted to operate in other rendering modes according to the temperature or other device parameters.

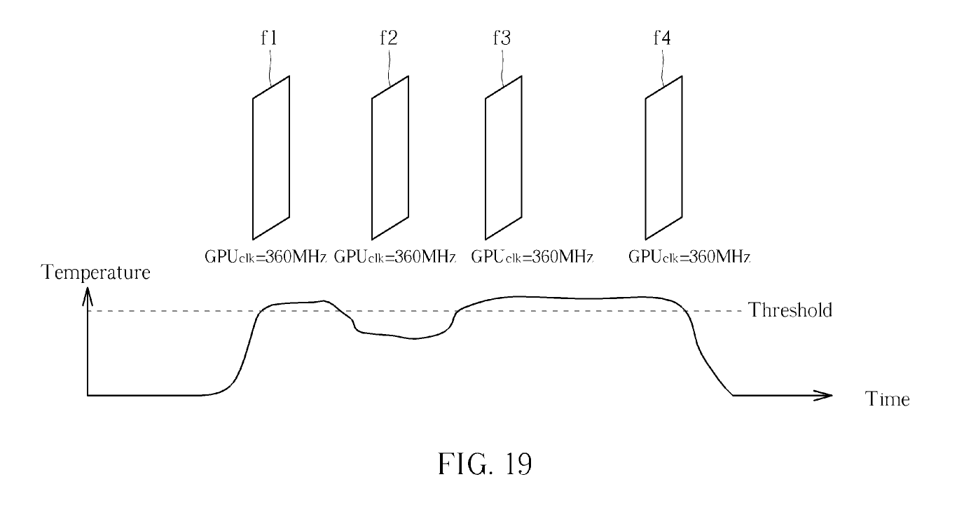

In view of above-mentioned description, the device parameter can be various kinds of parameters. In the embodiments of FIG. 19-24, the current is replaced with a frame resolution or a frame write speed. The higher frame resolution, the devices in the graphic processing module needs more power or time to process the frame, thus the temperature may accordingly increase. The frame write speed is a parameter indicating the speed for the graphic engine to write pixels to a memory device. In one embodiment, the frame write speed is indicated by a fill rate, but not limited. The higher the frame write speed is, the graphic module may have a higher temperature.

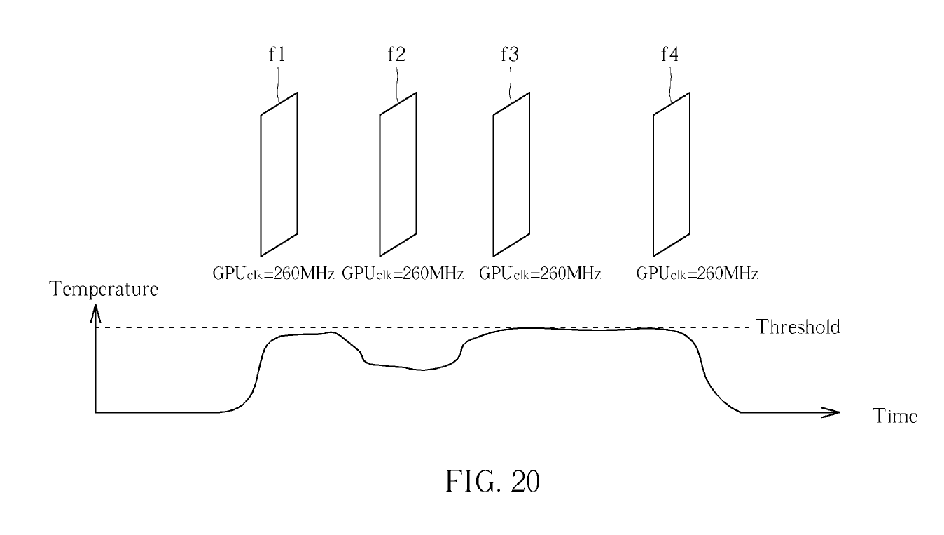

In the embodiments depicted of FIG. 19, FIG. 20, the operating speed for the graphic engine is adjusted based on the frame resolution or the frame write speed of the graphic engine. As above-mentioned, the operating speed is adjusted via adjusting a clock rate of the graphic engine in the embodiment depicted in FIG. 19 and FIG. 20. However, other methods can be applied to adjust the operating speed of the graphic engine. Further, the combination of the operating speed, the frame resolution or the frame write speed of the graphic engine can be applied to other devices of the graphic processing module, for example, the memory device, or the panel driver IC.

Please refer to FIG. 19, the graphic engine initially operates at the clock rate 360 MHz at the time points for drawing frames f1, f2, f2, f3, f4. Further, the frame resolution is set to 4K and the frame write speed is set to 1 gigapixels per second. However, the temperature is over a temperature threshold value at the time points for drawing frames f1, f3, f4. Accordingly, in the embodiment of FIG. 20, the clock rates for the graphic engine at the time points for drawing frames f1, f2, f3, f4 are adjusted to 260 MHz. By this way, the temperature at the time points for drawing frames f1, f3, f4 may be suppressed correspondingly. Please note, the clock rates in FIG. 19 and FIG. 20 are adjusted based on the frame resolution or the frame write speed, rather than the temperature, thus the clock rate is adjusted for the time points for all frames f1, f2, f3, f4, rather than only the time points for frames f1, f3, f4.

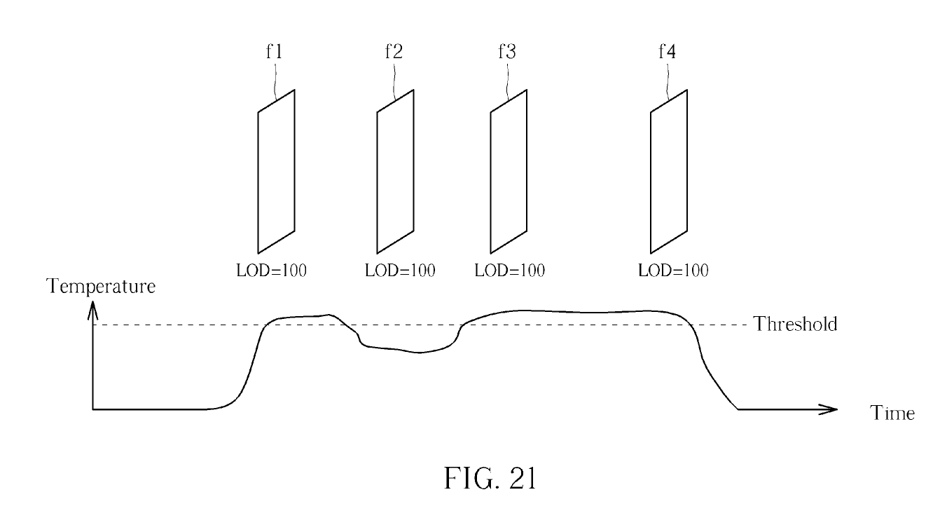

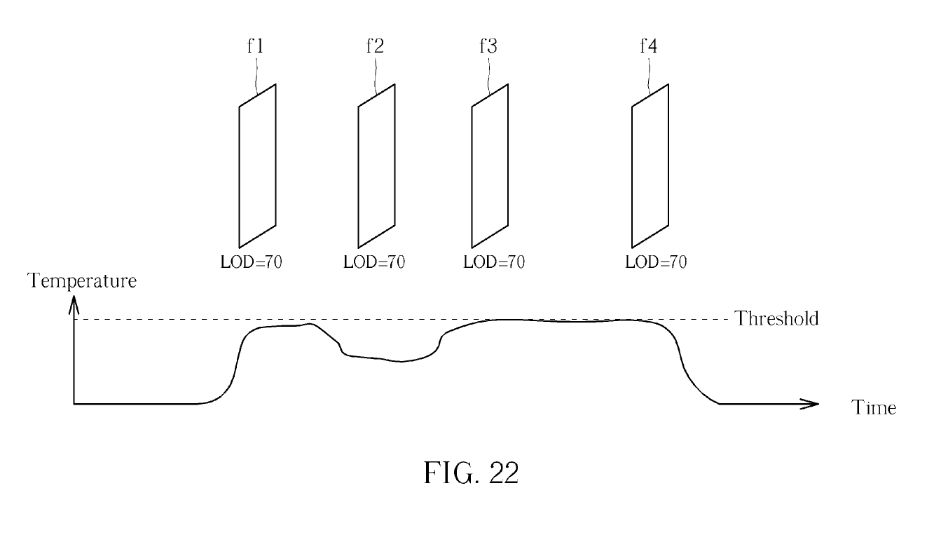

In the embodiments depicted in FIG. 21, FIG. 22, the frame detail level for the graphic engine is adjusted based on the frame resolution or the frame write speed. As above-mentioned, the frame detail level is a parameter indicating how detail does the graphic engine draws the frame. In the embodiments of FIG. 21, FIG. 22, the frame detail level is indicated by a LOD (level of detail) value, the higher the LOD value, the more detail for frame drawn by the graphic engine.

Please refer to FIG. 21, the graphic engine is set to higher LOD values for frames f1, f2, f3, f4. Further, the frame resolution is set to 4K and the frame write speed is set to 1 gigapixels per second. For such setting, the temperature is over a temperature threshold value at the time points for drawing frames f1, f3, f4, since the LOD value, the frame resolution and the frame write speed are high. Accordingly, in the embodiment of FIG. 22, the LOD values for the frames f1, f2, f3, f4 are decreased to 70. By this way, the temperature at the time points for drawing frames f1, f3, f4 may be suppressed correspondingly. Please note, the LOD values in FIG. 21 and FIG. 22 are adjusted based on the frame resolution or the frame write speed, rather than the temperature, thus LOD values for all frames are adjusted.

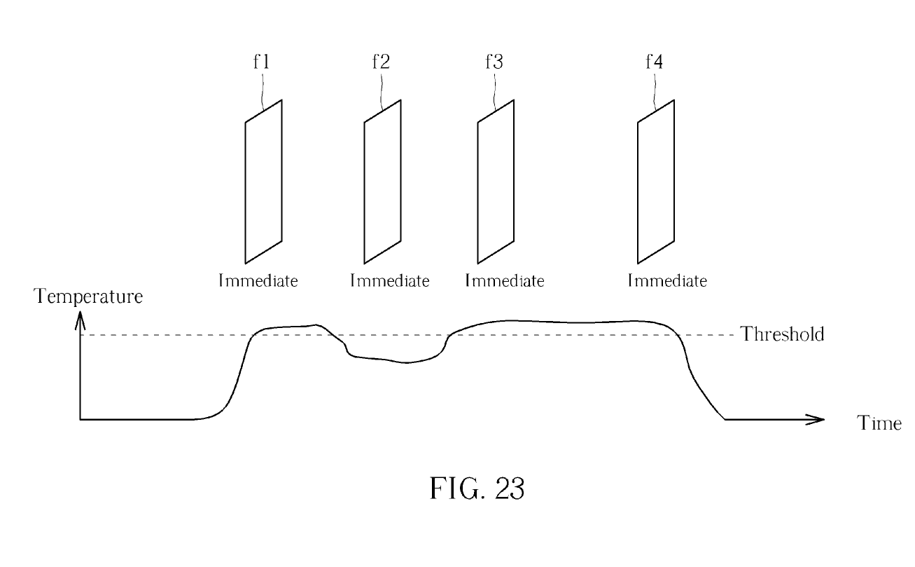

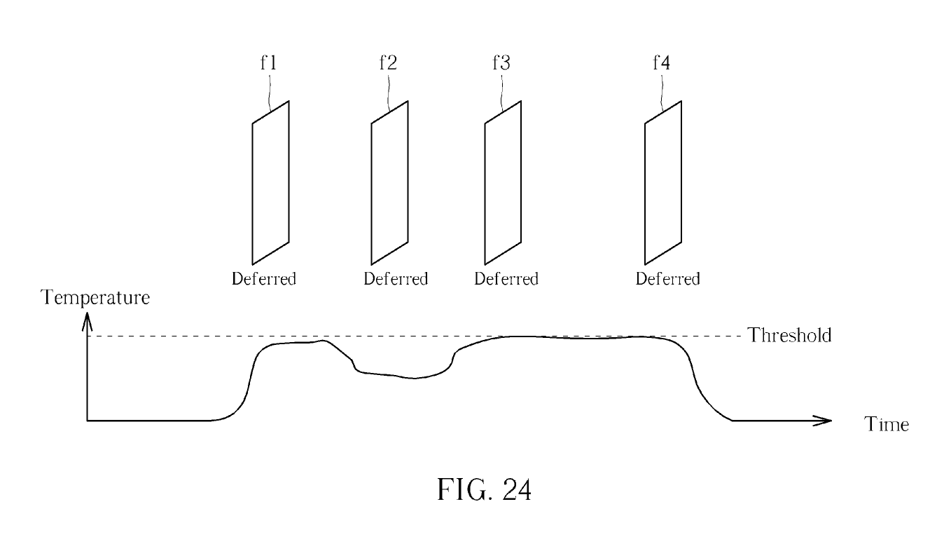

In the embodiments depicted in FIG. 23, FIG. 24, the rendering mode for the graphic engine is adjusted based on the frame resolution or the frame write speed. As described in the embodiments of FIG. 11 and FIG. 12, the rendering mode indicates how the frame is drawn. Also, the rendering mode may be selected from an immediate mode consuming more power and a deferred mode consuming less power.

Please refer to FIG. 23, the graphic engine operates in the immediate mode to draw frames f1, f2, f3, f4. Further, the frame resolution is 4K and the frame write speed is 1 gigapixels per second. For such setting, the temperature is over a temperature threshold value at the time points for drawing frames f1, f3, f4, due to the combination of the immediate mode, and one of the frame resolution and the frame write speed are high. Accordingly, in the embodiment of FIG. 24, the graphic engine is adjusted to operate in the deferred mode to draw the frames f1, f2, f3, f4. By this way, the temperature at the time points for drawing frames f1, f3, f4 may be suppressed correspondingly. Please note, the rendering mode in FIG. 23 and FIG. 24 are adjusted based on the frame resolution or the frame write speed, rather than the temperature, thus the rendering mode for all frames are adjusted.

As above-mentioned, the immediate mode and the deferred mode are only examples for explaining. The graphic engine can be adjusted to operate in other rendering modes according to the temperature (or other device parameters).

In view of above-mentioned description, the second device can be various kinds of devices for the graphic processing module, and the operating parameter can be correspondingly varied. In above-mentioned embodiments, the second device may include the graphic engine, and the operating parameter may include at least one of the rendering mode, the speed and the level of detail. In another embodiment, the second device may include the display processor, and the operating parameter may include at least one of a frame resolution, a brightness value, the speed, and a sharpness value. In still another embodiment, the second device may include a driver IC, and the operating parameter may include at least one of a frame resolution. Further, the number for the pixels processed in the above-mentioned embodiments can be fixed over the whole adjusting process, and can be dynamically adjusted in a pre-defined period as well.

In view of above-mentioned embodiments, a thermal management method for controlling a temperature of a graphic processing module can be acquired. The method comprises: (a) acquiring at least one device parameter for at least one first device of the graphic processing module; and (b) adjusting at least one operating parameter for at least one second device of the graphic processing module according to the device parameter.

Based on above-mentioned embodiments, the temperature can be controlled via adjusting only a few devices, thus the performance for whole electronic apparatus would not greatly decrease.

Those skilled in the art will readily observe that numerous modifications and alterations of the device and method may be made while retaining the teachings of the invention. Accordingly, the above disclosure should be construed as limited only by the metes and bounds of the appended claims.

1. A thermal management method, comprising:
(a) acquiring at least one device parameter corresponding to a first device of a graphic processing module; and
(b) adjusting at least one operating parameter for a second device of the graphic processing module according to the device parameter to control a temperature of a graphic processing module.

2. The thermal management method of claim 1, wherein the device parameter is generated by at least one operation performed by the first device.

3. The thermal management method of claim 1, wherein the device parameter is a configuration parameter of the first device.

4. The thermal management method of claim 1, further comprising:
determining at least one temperature for the first device of the graphic processing module according to the device parameter;
wherein the step (b) adjusts the operating parameter according to the determined temperature.

5. The thermal management method of claim 4, further comprising:
measuring an environment temperature; and
adjusting the determined temperature for the first device of the graphic processing module based on the environment temperature to generate an adjusted temperature;
wherein the step (b) adjusts the operating parameter according to the adjusted temperature.

6. The thermal management method of claim 1,
wherein the graphic processing module comprises at least one of following devices: a display processor, a memory device, a panel driver IC, a display panel and a graphic engine

7. The thermal management method of claim 1, wherein the device parameter comprises at least one of: a temperature, a current value, a signal delay value, a frame resolution, a frame write speed (fillrate), and a power consumption value.

8. The thermal management method of claim 1, wherein the operating parameter comprises at least one of: an operating speed, a frame detail level, a rendering mode, a frame resolution, a brightness value, a sharpness value and an operating voltage.

9. The thermal management method of claim 1, wherein the device parameter comprises a current value, and the operating parameter comprises at least one of an operating speed, a frame detail level, and a rendering mode.

10. The thermal management method of claim 1, wherein the device parameter comprises a frame resolution or a frame write speed, and the operating parameter comprises at least one of an operating speed, a frame detail level, and a rendering mode.

11. An electronic system with a thermal control mechanism, comprising:
a graphic processing module, configured to process graphic data;
a parameter acquiring device, configured to acquire at least one device parameter corresponding to a first device of a graphic processing module; and
a thermal management device, configured to adjust at least one operating parameter for at least second device of the graphic processing module according to the device parameter to control a temperature of a graphic processing module.

12. The electronic system of claim 11, wherein the device parameter is generated by at least one operation performed by the first device.

13. The electronic system of claim 11, wherein the device parameter is a configuration parameter of the first device.

14. The electronic system of claim 11, wherein the thermal management device further determines at least one temperature for the first device of the graphic processing module according to the device parameter, and adjusts the operating parameter according to the determined temperature.

15. The electronic system of claim 14, wherein the thermal management device further measures an environment temperature, and adjusts the determined temperature for the first device of the graphic processing module based on the environment temperature to generate an adjusted temperature; wherein the thermal management device adjusts the operating parameter according to the adjusted temperature.

16. The electronic system of claim 11,
wherein the graphic processing module comprises at least one of following devices: a display processor, a memory device, a panel driver IC, a display panel and a graphic engine.

17. The electronic system of claim 11, wherein the device parameter comprises at least one of: a temperature, a current value, a signal delay value, a frame resolution, a frame write speed (fillrate), and a power consumption value.

18. The electronic system of claim 11, wherein the operating parameter comprises at least one of: an operating speed, a frame detail level, a rendering mode, a frame resolution, a brightness value, a sharpness value and an operating voltage.

19. The electronic system of claim 11, wherein the device parameter comprises a current value, and the operating parameter comprises at least one of an operating speed, a frame detail level, and a rendering mode.

20. The electronic system of claim 11, wherein the device parameter comprises a frame resolution or a frame write speed, and the operating parameter comprises at least one of an operating speed, a frame detail level, and a rendering mode.
